(19) United States
(12) Patent Application Publication
(10) Pub. No.: US 2019/0057282 A1
(43) Pub. Date: Feb. 21, 2019

(54) CARBONIZATION TIME POINT MANAGEMENT SERVICE PROVIDING SYSTEM FOR COOKING FISH-MEAT STUFF

(71) Applicant: ZAIGLE CO.,LTD, Seoul (KR)

(72) Inventor: Jin Hee LEE, Seoul (KR)

(73) Assignee: ZAIGLE CO.,LTD, Seoul (KR)

(21) Appl. No.: 16/102,956

(22) Filed: Aug. 14, 2018

(30) Foreign Application Priority Data
Aug. 16, 2017 (KR) 10-2017-0103377

(51) Int. Cl. G06K 9/62; A47J 37/07; G06T 7/90

(52) U.S. Cl. CPC G06K 9/6211; G06T 2207/10024; G06T 7/90; A47J 37/0786

(57) ABSTRACT

Provided is a carbonization time point management service providing system when food stuff such as fish or meat (or fish-meat stuff) cooked, the system receives, from a cooking management service providing server, fish-meat detecting information including a cooking time from a cooking start point in time of fish-meat stuff to a carbonization time point at which the fish-meat stuff starts to be carbonized, generates a cooking completion acquisition signal in accordance with an end timing of the cooking time, and transmits a cooking completion indication signal to cooking management dedicated application content, so that the cooking completion indication signal is externally displayed, thereby enabling real-time confirmation of a cooking process of fish-meat stuff which is placed on a heating device even in the case of performing the other work at the remote place during cooking of the fish-meat stuff, to improve convenience when cooking the fish-meat stuff.

### TECHNICAL FIELD

The present disclosure relates to a system for providing a carbonization point-in-time (hereinafter referred to as time point) management service providing system when food stuff such as fish or meat (hereinafter, referred to an fish-meat stuff) is cooked, and more particularly to a carbonization time point management service providing system that receives, from a cooking management service providing server, fish-meat detecting information including a cooking time from a cooking start point in time of fish-meat stuff to be cooked to a carbonization time point at which the fish-meat stuff starts to be carbonized, generates a cooking completion acquisition signal in accordance with an end timing of the cooking time, and transmits a cooking completion indication signal to a cooking management dedicated application content, so that the cooking completion indication signal is displayed on the outside.

### CONVENTIONAL ART

As life is getting better and eating habits become more widespread, the intake of various kinds of meat such as beef, pork, chicken, and duck, and various kinds of fish is increasing.

In general, roasting is done by putting a grill plate on the top of a hearth containing a heat source such as charcoal, and grilling meat or the like on the grill plate with the meat or the like on top.

However, this general roasting method has the problem that, when the firepower is excessively strong or the grill plate is over-heated, only the surface of the meat becomes burnt and the inside of the meat becomes unripe. In recent years, interest in health has increased, and interest in ways to cook with the best taste and texture without burning meat is increasing.

As a part of this, products based on the technology of cooking fish-meat stuff using infrared rays have been proposed. Fish-meat stuff is grilled by a heat source generated from an infrared lamp generating infrared wavelength light so that the inside and outside of the fish-meat stuff can be uniformly cooked without burning the fish-meat stuff. Meanwhile, in order to make life more convenient, development efforts have been actively made on application technologies for applying dedicated application content to various household appliances. However, in general, when the grill plate is heated by the infrared rays as the heat source and the food to be grilled is placed on the grill plate, the food to be grilled is cooked by the light of infrared rays and thus it is difficult to distinguish the changing color of the food. As a result, it is difficult to confirm whether or not the food is grilled well.

### PRIOR ART DOCUMENTS

(Patent Document 1) Korean Patent Application Publication No. 10-2016-0126223

(Patent Document 2) Korean Patent Application Publication No. 10-2013-0071732

(Patent Document 3) Korean Patent Application Publication No. 10-2014-0112079

(Patent Document 4) Korean Patent Application Publication No. 10-2014-0095098

### DISCLOSURE

### Technical Problem

It is an object of the present disclosure to provide a carbonization time point management service providing system which enables real-time confirmation of a cooking process of fish-meat stuff which is placed on a heating device for cooking the fish-meat stuff even in the case of performing the other work at the remote place during cooking of the fish-meat stuff, to improve convenience when cooking the fish-meat stuff.

In addition, it is another object of the present disclosure to provide a carbonization time point management service providing system which enables reproduction of character images, music, and moving images through dedicated application content loaded on a portable terminal at a time waiting for fish-meat stuff to be cooked in the course of cooking the fish-meat stuff, to thereby eliminate boredom during cooking. In addition, it is another object of the present disclosure to provide a carbonization time point management service providing system which enables displaying calorie information about the fish-meat stuff being consumed during cooking in dedicated application content, to thus provide a product capable of meeting the needs of modern people who are interested in diets.

In addition, it is another object of the present disclosure to provide a carbonization time point management service providing system which improves advertising efficiency of an advertisement product even when a separate advertising medium is not used by connecting advertisement data of the product and a website for purchasing the product during use of a heating device for cooking fish-meat stuff.

In addition, it is another object of the present disclosure to provide a carbonization time point management service providing system capable of easily recognizing the degree of cooking of foods even when grilling foods by heating the foods to be grilled with infrared rays as a heat source.

### Technical Solution

According to an aspect of the present disclosure, there is provided a system for providing a carbonization time point management service for cooking fish-meat stuff, the carbonization time point management service providing system comprising: a heating device for cooking fish-meat stuff in which the heating device photographs fish-meat stuff to be cooked on a cooking plate with a camera and transmits the photographed image of the fish-meat stuff to a portable terminal.

In addition, the heating device for cooking fish-meat stuff is connected to a cooking management service providing server performing a method comprising: estimating the type of the fish-meat stuff to be cooked and a carbonization time point by 1:1 mutual comparison with a previously stored fish-meat stuff identification image based on a fish-meat stuff photographed image; detecting the kind of the estimated fish-meat stuff to be cooked and the heat required for cooking; and providing fish-meat detecting information for controlling a cooking time to a portable terminal equipped with cooking management dedicated application content.

In addition, the heating device for cooking fish-meat stuff and the cooking management service providing server are connected to a portable terminal performing a method comprising: transmitting the image of the fish-meat stuff taken from the heating device for cooking the fish-meat stuff to the cooking management service providing server, to thereafter receive the fish-meat stuff detecting information from the cooking management service providing server; generating a cooking completion acquisition signal in accordance with an end timing of the cooking time from a cooking start time point at which the fish-meat stuff to be cooked confirmed from the fish-meat stuff detecting information to a carbonization time point at which the fish-meat stuff to be cooked begins to carbonize; and transmitting the cooking completion acquisition signal to the cooking management dedicated application content to process a cooking completion indication signal to be informed to the outside.

Further, according to another aspect of the present disclosure, there is provided a cooking management service providing server comprising: a fish-meat identification unit for identifying a type of the fish-meat stuff to be cooked and a specific part of the fish-meat stuff to be cooked by comparing the fish-meat stuff received from a portable terminal with pre-stored fish-meat stuff identification images on a one-to-one basis; a cooking time setting unit for predicting the cooking time from the cooking start time point to the carbonization time point at which the fish-meat stuff to be cooked starts to carbonize according to the type of the fish-meat stuff to be cooked; an information providing unit providing the fish-meat stuff detecting information including the type of the fish-meat stuff to be cooked and the cooking time to the portable terminal equipped with the cooking management dedicated application content; a content providing unit providing at least one of customized character images, music, and images corresponding to a portable terminal holder who has determined priority based on a preference based on age, gender, occupation, and hobby acquired from the personal information of the portable terminal holder, to the portable terminal equipped with the cooking management dedicated application content; and a calorie information providing unit receiving a weight measurement value of the fish-meat stuff to be cooked placed for each of the divided regions of the cooking plate from the portable terminal and providing calorie information obtained by converting the weight of the fish-meat stuff to be cooked into a calorie value to the portable terminal equipped with the cooking management dedicated application content.

Meanwhile, there is provided a method of driving a carbonization time point management service providing system during cooking fish-meat stuff, the driving method comprising: by a heating device for cooking the fish-meat stuff, photographing fish-meat stuff to be cooked which is placed on a cooking plate with a camera of the heating device and transmitting the photographed image of the fish-meat stuff to the portable terminal; and by a cooking management service providing server, performing a method comprising estimating the type of the fish-meat stuff to be cooked and a carbonization time point by 1:1 mutual comparison with a previously stored fish-meat stuff identification image based on a fish-meat stuff photographed image and providing fish-meat detecting information including the type of the fish-meat stuff to be cooked and the cooking time to the portable terminal equipped with cooking management dedicated application content; by the portable terminal, performing a method comprising: transmitting the image of the fish-meat stuff taken from the heating device for cooking the fish-meat stuff to the cooking management service providing server, to thereafter receive the fish-meat stuff detecting information from the cooking management service providing server; generating a cooking completion acquisition signal in accordance with an end timing of the cooking time from a cooking start time point at which the fish-meat stuff to be cooked confirmed from the fish-meat stuff detecting information to a carbonization time point at which the fish-meat stuff to be cooked begins to carbonize; and transmitting the cooking completion acquisition signal to the cooking management dedicated application content to process a cooking completion indication signal to be informed to the outside.

### BRIEF DESCRIPTION OF THE DRAWINGS

FIG. 1 is a diagram illustrating a configuration of a carbonation time point management service providing system for cooking fish-meat stuff according to an embodiment of the present disclosure.

FIG. 2 is an exemplary view showing divided regions of a cooking plate according to an embodiment.

FIG. 3 is a block diagram showing a configuration of a cooking management service server according to an embodiment of the present disclosure.

FIG. 4 is a block diagram illustrating a configuration of a portable terminal equipped with cooking management dedicated application content according to an embodiment of the present disclosure.

FIG. 5 is a flow chart illustrating a drive method of driving a carbonation time point management service providing system for cooking fish-meat stuff according to an embodiment of the present disclosure.

### BEST MODE

It is noted that the technical terms used in the present disclosure are used only to describe specific embodiments and are not intended to limit the present disclosure. Also, the technical terms used in the present disclosure should be construed in a sense generally understood by a person having ordinary skill in the art to which the present disclosure belongs, unless otherwise defined in the present disclosure. It should not be construed to be interpreted in an overly comprehensive sense, or be interpreted in an excessively reduced sense. In addition, when a technical term used in the present disclosure is an erroneous technical term that does not accurately express the concept of the present disclosure, it should be understood that it is replaced with a technical term that a person skilled in the art understands correctly. In addition, the general terms used in the present disclosure should be interpreted according to a predefined or prior context, and should not be construed as being excessively reduced. In addition, the singular expressions used in the present disclosure include plural expressions unless the context clearly indicates otherwise. In the present disclosure, the terms such as “comprising” or “comprises” and the like should not be construed as all-encompassing various elements or stages of the invention, but should be construed as not including some of the elements or some of the steps, or as further including additional components or steps.

Hereinafter, preferred embodiments of the present disclosure will be described in detail with reference to the accompanying drawings, wherein like reference numerals are used to designate identical or similar elements, and redundant description thereof will be omitted. In the following description of the present disclosure, detailed description of related arts will be omitted if it is determined that the gist of the present disclosure may be blurred. In addition, it is to be noted that the accompanying drawings are only for the purpose of facilitating understanding of the present disclosure, and should not be construed as limiting the scope of the present disclosure with reference to the accompanying drawings.

Hereinafter, the present disclosure will be described with reference to the accompanying drawings.

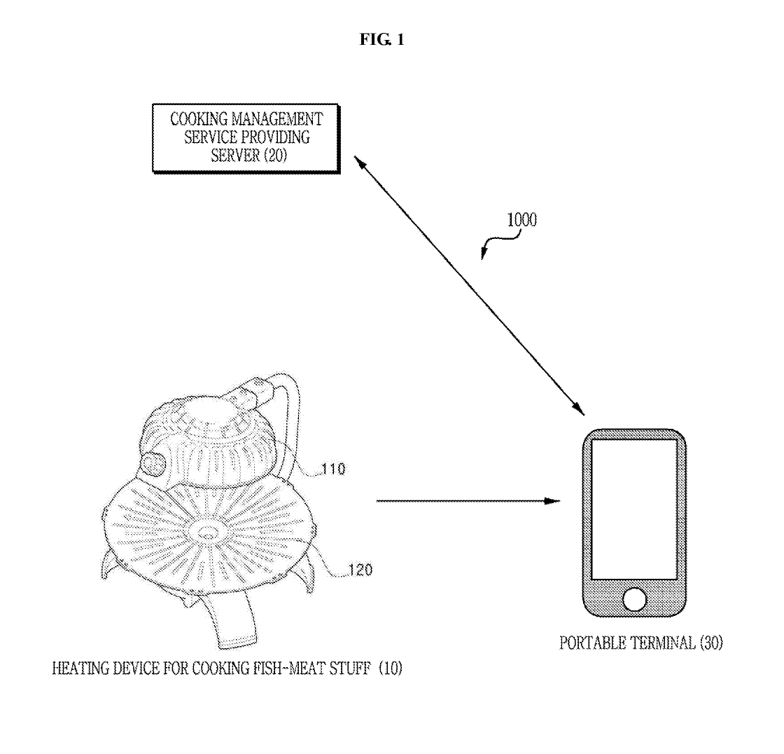

FIG. 1 is a diagram illustrating a configuration of a carbonation time point management service providing system for cooking fish-meat stuff according to an embodiment of the present disclosure. As shown in FIG. 1, a system 1000 for providing a carbonization time point management service for cooking fish-meat stuff in accordance with one embodiment includes a heating device 10 for cooking fish-meat stuff, a cooking management service providing server 20, and a portable terminal 30. The heating device 10 for cooking fish-meat stuff photographs fish-meat stuff to be cooked which is placed on a cooking plate with a camera of the heating device and transmits the photographed image of the fish-meat stuff to the portable terminal 30.

In this case, the heating device 10 according to an embodiment can use infrared rays as a heat source. Since the red light generated during cooking makes it difficult to visually discriminate the degree of the cooking of the fish-meat stuff to be cooked, it is possible to photograph the fish-meat stuff to be cooked through the camera to clearly check the degree of the cooking of the fish-meat stuff to be cooked.

In one embodiment, the heating device 10 for cooking fish-meat stuff includes a heat source supply unit 110, a cooking plate 120, a camera (not shown), a communication unit (not shown), and a weight measuring unit (not shown).

The heat source supply unit 110 directs infrared rays on the upper side of the cooking plate 120 to heat the fish-meat stuff to be cooked put on the cooking plate 120. The cooking plate 120 is configured to heat the fish-meat stuff to be cooked. The camera shoots the fish-meat stuff to be cooked on the cooking plate. In one embodiment, the camera may be a small and lightweight camera module. Preferably, the camera is mounted above the heat source supply unit 110. Accordingly, damage to the camera due to heat generated in the heat source supply unit can be minimized.

The communication unit includes a short-range wireless communication module. The short-range wireless communication module may be a communication module such as Bluetooth, Wi-Fi, Zig bee, or NFC (Near Field Communication). However, the short-range wireless communication module is not limited thereto. In one embodiment, the communication unit transmits the photographed image of the fish-meat stuff taken by the camera to the portable terminal 30 equipped with the cooking management dedicated application content.

The weight measuring unit measures the weight of the fish-meat stuff to be cooked placed on the cooking plate 120. In one embodiment, the weight measuring unit is implemented as a scale or a weight sensing sensor for measuring the weight of the fish-meat stuff to be cooked by measuring the weight increase when the fish-meat stuff is put on the cooking plate. In one aspect, at least one weight measuring unit provided in the heating device 10 for cooking fish-meat stuff is disposed for each of the divided regions of the cooking plate 120, and the weight of the fish-meat stuff to be cooked placed for each divided region of the cooking plate is measured.

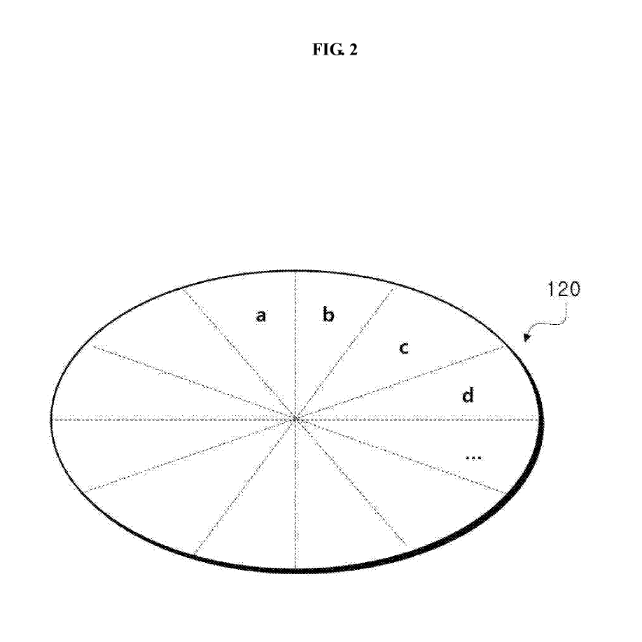

FIG. 2 is an exemplary view showing divided regions of a cooking plate according to an embodiment.

For example, the weight measuring unit may be provided for each of the divided regions (a, b, c, d, . . . ) divided by 30 degrees at the center as shown in FIG. 2. That is, the weight of the fish-meat stuff to be cooked put on each divided region can be measured. However, the weight measuring unit is not limited thereto, but the number and position of the weight measuring units disposed on the cooking plate 120 are variously variable. The cooking management service providing server 20 estimates the type of the fish-meat stuff to be cooked and the carbonization time point thereof by mutually comparing a previously stored fish-meat stuff discrimination image with the fish-meat stuff photographed image on a 1:1 basis, based on the fish-meat stuff photographed image received from the portable terminal 30. Further, the heating device 10 for cooking fish-meat stuff detects the type of fish-meat stuff to be cooked and the heat required for cooking, thereby providing fish-meat stuff detecting information capable of controlling a cooking time. to a portable terminal 30 equipped with cooking management dedicated application content

That is, the heating device 10 for cooking fish-meat stuff includes a heat sensing sensor (not shown) for sensing necessary heat while cooking the fish-meat stuff to be cooked on a cooking plate and a cooking time setting unit (not shown) for controlling a cooking time by sensed heat to perform cooking management in response to the detecting information of the fish-meat stuff.

Here, the cooking time setting unit can display the execution information to be cooked and managed in correspondence with the detecting information of the fish-meat stuff while being stored in the heating device 10 for cooking the fish-meat stuff, through a display (not shown), and can transmit the execution information via the communication unit and communicate with the outside to then be externally controlled. In addition, the information photographed by the camera may be stored in a storage medium (not shown) provided in the cooking plate 120 and storing information photographed by the camera, and such a storage medium may be taken out to thus reproduce the information stored in the storage medium through an external display (not shown).

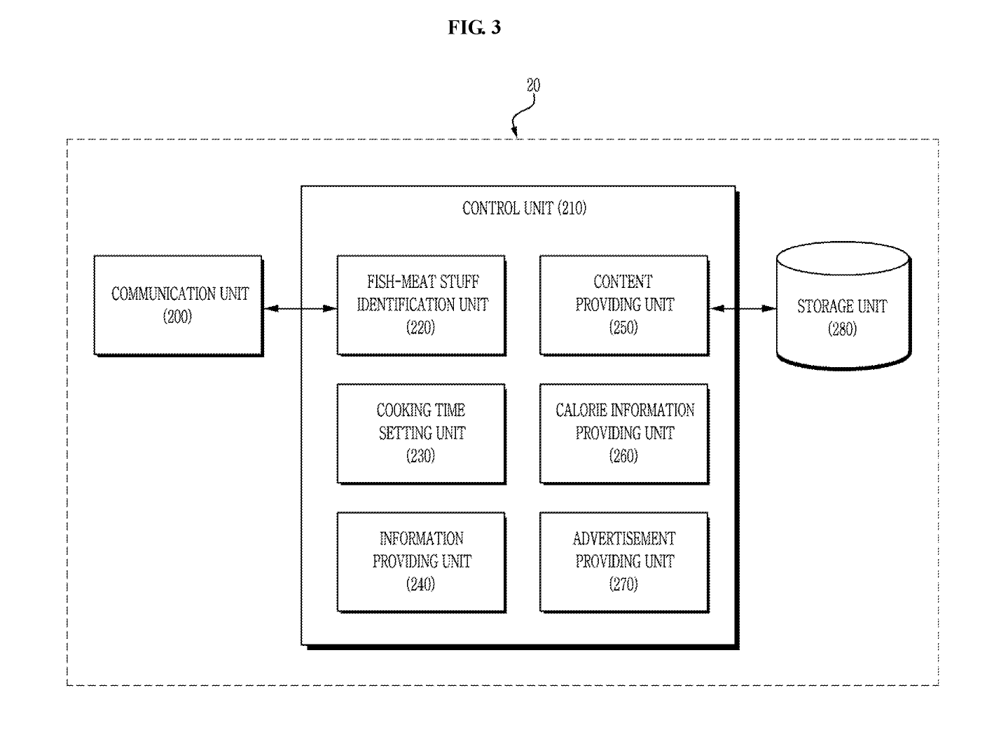

FIG. 3 is a block diagram showing a configuration of a cooking management service server according to an embodiment of the present disclosure. As shown in FIG. 3, the cooking management service server 20 includes a communication unit 200, a control unit 210, and a storage unit 280.

The communication unit 200 includes a wired/wireless communication module and performs data communication with the portable terminal.

The storage unit 280 is implemented as a memory module in which data is stored. In one embodiment, the storage unit 280 stores a discrimination image of fish-meat stuff for discriminating the type of fish-meat stuff to be cooked. Here, it is obvious that the information stored in the storage unit 280 can be added and updated by an access authorized administrator.

The control unit 210 is implemented by a microprocessor module and a program stored and driven therein. Specifically, the control unit 210 includes a fish-meat stuff identification unit 220, a cooking time setting unit 230, an information providing unit 240, a content providing unit 250, a calorie information providing unit 260, and an advertisement providing unit 270. The fish-meat stuff identification unit 220 performs a 1:1 match and mutually compares a previously stored fish-meat stuff discrimination image with the fish-meat stuff photographed image received from the portable terminal 30 via the communication unit 200 with each other. In one embodiment, the fish-meat stuff identification unit 220 detects the shape or color of the fish-meat stuff piece to be cooked from the fish-meat stuff photographed image and compares the detected shape or color of the fish-meat stuff piece with the pre-stored fish-meat discrimination image. The discrimination image of the fish-meat stuff can be implemented as a sample image showing the shape or color of each kind and part of various types of fish-meat stuff.

However, the discrimination image of the fish-meat stuff is not limited thereto, but may be interpreted to encompass various technical measures that can be used to determine whether a match is made through image comparison. The fish-meat stuff identification unit 220 can be set to recognize that the match is equal to or greater than 80 to 90%, for example, between the fish-meat stuff photographed image and the fish-meat stuff discrimination image. The fish-meat stuff identification unit 220 identifies the type of the fish-meat stuff to be cooked and the specific part of the fish-meat stuff to be cooked by comparing and determining the images. The cooking time setting unit 230 estimates a cooking time from a cooking start time point to a carbonization start time point of the fish-meat stuff to be cooked in which the fish-meat stuff to be cooked begins to carbonize, depending on the type of fish-meat stuff to be cooked identified in the fish-meat stuff identification unit 220.

According to one aspect, the cooking time setting unit 230 calculates a cooking time based on a relational expression

$$cooking time = \frac{type of fish or meat stuff \times thickness}{temperature of cooking plate} .$$

That is, the cooking time setting unit 230 reflects the thickness of the fish-meat stuff to be cooked, which is roughly grasped from the photographed image of the fish-meat stuff, and the higher the cooking plate temperature is, and the thinner the thickness of the cooking plate is, the shorter the cooking time is. The information providing unit 240 provides the fish-meat stuff detecting information including the type of the fish-meat stuff to be cooked identified by the fish identification unit 220 and the cooking time calculated by the cooking time setting unit 230, to the portable terminal 30 equipped with the cooking management dedicated application content. The content providing unit 250 provides information on at least one of customized character images, music, and images corresponding to a portable terminal holder who has determined priority based on a preference based on age, gender, occupation, and hobby acquired from the personal information of the portable terminal holder, to the portable terminal 30. For example, one of the customized character images may be a custom character's dance image to the taste of a portable terminal holder. Accordingly, it is possible to save the boredom waiting for the cooking time of the fish-meat stuff to be cooked.

The personal information of the portable terminal holder of the content providing unit 250 is obtained from the communication company server, or may be based on information collected under the consent of the portable terminal holder at the time of initially installing the cooking management dedicated application content.

The calorie information providing unit 260 converts a weight of the fish-meat stuff to be cooked received from the portable terminal 30 into a calorie value. The converted calorie information is provided to the portable terminal 30 through the communication unit 200. The conversion of the weight to the calorie value can be calculated by applying a weight value of the fish-meat stuff to be cooked, which is put on each of the divided regions to a ratio value set according to the type of the fish-meat stuff. The advertisement providing unit 270 provides the banner advertisement data to the portable terminal 30 equipped with the cooking management dedicated application content. Further, when the portable terminal 30 recognizes that at least a part of the banner advertisement data is clicked, a purchase website linked with the banner advertisement data is displayed on the cooking management dedicated application content. Here, the advertisement providing unit 270 provides the web page address information of the purchase website linked with the banner advertisement data simultaneously, together with the banner advertisement data, or may provide the web page address information of the purchase website linked with the banner advertisement data after the click of the banner advertisement is recognized.

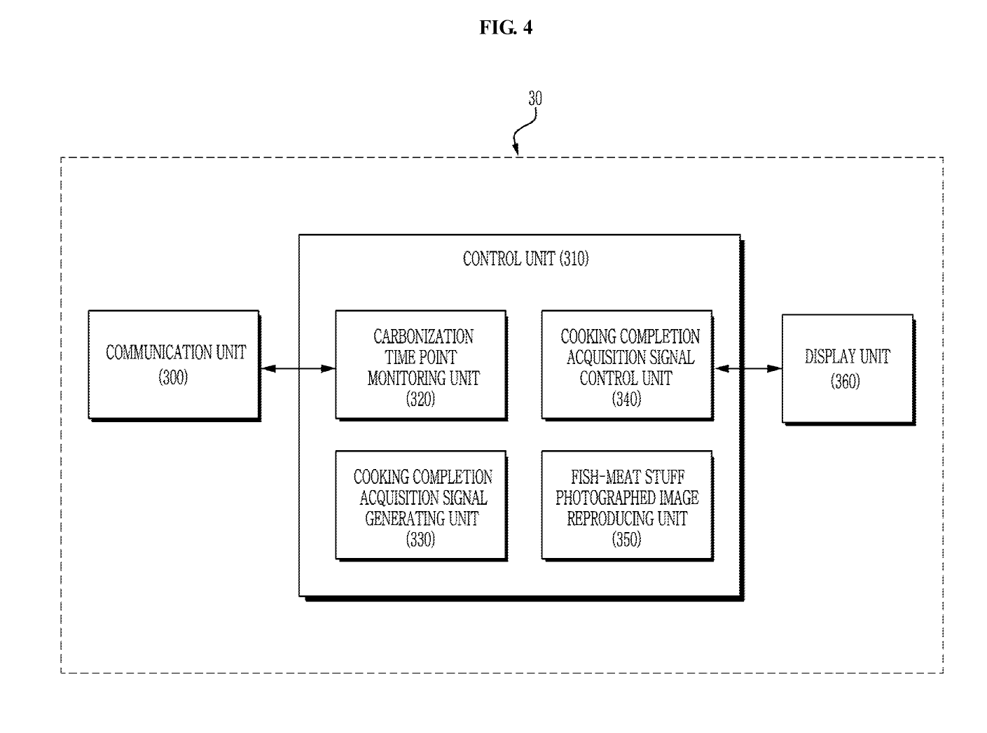

FIG. 4 is a block diagram illustrating a configuration of a portable terminal equipped with cooking management dedicated application content according to an embodiment of the present disclosure. The portable terminal 30 includes a communication unit 300, a control unit 310, and a display unit 360. The communication unit 300 includes both a short-range local communication module for communicating with the heating device 10 for cooking fish-meat stuff and a wired/wireless communication module for communicating with the cooking management service providing server 20.

The display unit 360 is implemented as a display screen mounted on the portable terminal 30.

In one embodiment, the display unit 360 is a screen for reproducing cooking management dedicated application content, and displays a photographed image of fish-meat stuff received from the heating device 10 for cooking the fish-meat stuff through the communication unit 300 in real time. The control unit 310 is implemented by a microprocessor module and a program stored and driven therein. Specifically, the control unit 310 includes a carbonization time point monitoring unit 320, a cooking completion acquisition signal generating unit 330, a cooking completion display signal control unit 340, and a fish-meat stuff photographing image reproducing unit 350.

The portable terminal 30 transmits the photographed image of the fish-meat stuff received from the heating device 10 for cooking the fish-meat stuff through the communication unit 300 to the cooking management service providing server 20.

The carbonization time point monitoring unit 320 receives the fish-meat stuff detecting information from the cooking management service providing server 20, and grasps, from the received fish-meat stuff detecting information to the target fish-meat stuff to be cooked, the cooking time from the cooking start time point to the carbonization time point in which the fish-meat stuff starts to be carbonized to monitor the arrival of the carbonization time is monitored.

The cooking completion acquisition signal generating unit 330 generates a cooking completion acquisition signal in accordance with the end timing of the cooking time when the carbonization time point monitoring unit 320 obtains the carbonization timing.

The cooking completion display signal control unit 340 delivers the cooking completion acquisition signal generated by the cooking completion acquisition signal generating unit 330 to the cooking management dedicated application content to perform signal processing so that the cooking completion display signal is notified to the outside. The cooked completion display signal can be displayed visually or audibly or both in the form of external notification.

According to one aspect, the fish-meat stuff photographed image reproducing unit 350 displays, on the display unit 360, the fish-meat stuff photographed image received through the communication unit 300 from the heating device 10 for cooking fish-meat stuff using cooking management dedicated application content during the cooking time.

According to a further aspect, in reproducing the fish-meat stuff photographed image, the fish-meat stuff photographed image reproducing unit 350 reproduces the fish-meat stuff photographed image into which at least one of customized character images, music, and images corresponding to a portable terminal holder who has determined priority based on a preference based on age, gender, occupation, and hobby acquired from the personal information of the portable terminal holder is inserted, in the form of a video image. For example, if a cell phone holder is a housewife in the mid-30s, images such as ballad music, pop songs, and music videos with high preference in the age range can be displayed. If the cell phone holder is a man in the 60s, a part of trot music or a favorite drama or movie can be played back. Otherwise, a dance or song video of a favorite entertainer or character may be displayed. Accordingly, the boredom waiting for cooking the fish-meat stuff to be cooked can be saved. In accordance with another aspect, when reproducing the fish-meat stuff photographed image, the fish-meat stuff photographed image reproducing unit 350

displays the kind and weight information of the fish-meat stuff to be cooked measured for each divided region of the cooking plate while overlapping with the fish-meat stuff photographed image. In other words, the type and weight information of the fish-meat stuff to be cooked, which are put on each of the divided regions of the cooking plate, are further displayed on the fish-meat stuff photographed image. Also, in displaying the fish-meat stuff photographed image, the fish-meat stuff photographed image reproducing unit 350 displays the calorie information, which is obtained by converting the weight of the fish-meat stuff to be cooked into the calorie value, while further overlapping with the fish-meat stuff photographed image. Therefore, it is possible to provide the convenience of the diet by making it possible to grasp the value of the intake calorie when the fish-meat stuff to be cooked placed on the cooking plate is taken in. In this case, the calorie information of the fish-meat stuff may be a value received from the cooking management service providing server 20 through the communication unit 300 or a value directly calculated based on the weight information within the portable terminal 30 itself.

According to a further aspect, the cooking completion acquisition signal generating unit 330 generates the cooking completion acquisition signals differently for each divided region of the cooking plate.

Then, the cooking completion display signal control unit 340 performs an on/off control of input/output values of the cooking completion display signal for causing at least one of the divided regions of the cooking plate to perform flickering or color conversion in accordance with the time point at which the cooking completion acquisition signal is generated. Therefore, it is possible to individually discriminate whether or not the time point for carbonization of the piece of the fish-meat stuff to be cooked which has been placed on any of the divided regions of the cooking plate has arrived. Here, the cooking completion acquisition signal generating unit 330 generates the cooking completion acquisition signal by further reflecting the optimum time for flipping, in which the flipping optimum time is calculated based on the relational expression

$$optimum time for flipping = \frac{cooking time}{2} .$$

Accordingly, by further notifying the flipping optimum time, it is possible to reverse the pieces of the fish-meat stuff to be cooked at the proper timing during the cooking process.

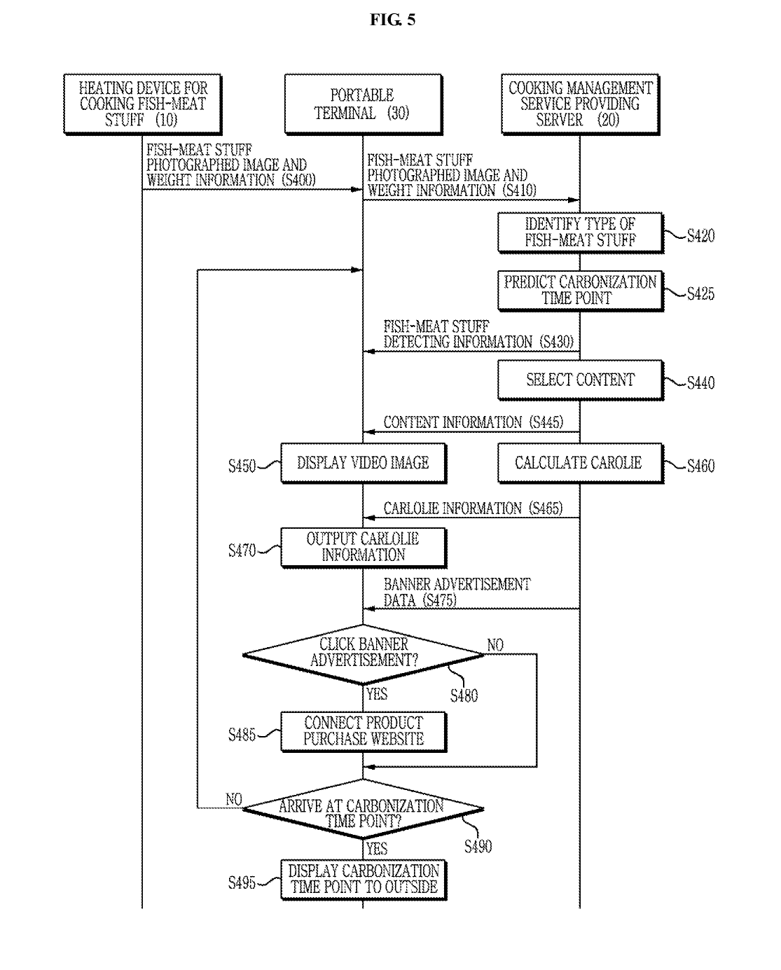

FIG. 5 is a flow chart illustrating a drive method of driving a carbonation time point management service providing system for cooking fish-meat stuff according to an embodiment of the present disclosure. First, the heating device 10 for cooking fish-meat stuff photographs fish-meat stuff to be cooked on a cooking plate with a camera. Then, the fish-meat stuff photographed image is transmitted to the portable terminal 30 (S400). In this case, weight information of the fish-meat stuff to be cooked is further transmitted to the portable terminal 30. The portable terminal 30 transmits the fish-meat stuff photographed image and the weight information received from the heating device 10 for cooking the fish-meat stuff to the cooking management service providing server 20.

The cooking management service providing server 20 estimates the type of the fish-meat stuff to be cooked (S420) and the time point of carbonization (S425) by comparing the received fish-meat stuff photographed image with the pre-stored fish-meat stuff discrimination image on a one-to-one basis. Then, in step S430, the fish-meat stuff detecting information including the type of the fish-meat stuff to be cooked and the cooking time is provided to the portable terminal 30 equipped with the cooking management dedicated application content. The cooking management service providing server 20 selects at least one of a personalized character image, music, image, and the like suitable for a portable terminal holder who has determined the priority based on the preference based on the age, gender, occupation, and hobby acquired from the personal information of the portable terminal holder, (S440) and provides the selected information to the portable terminal 30 (S445). For example, one of the customized character images may be a custom character's dance image to the taste of a portable terminal holder. In reproducing the fish-meat stuff photographed image through the cooking management dedicated application content, the portable terminal 30 reproduces the fish-meat stuff photographed image into which at least one of customized character images, music, and images corresponding to a portable terminal holder who has determined priority based on a preference based on age, gender, occupation, and hobby acquired from the personal information of the portable terminal holder is inserted, in the form of a video image.

The cooking management service providing server 20 calculates a calorie value by converting the weight of the fish-meat stuff to be cooked, which is received from the portable terminal 30, into the calorie value (S460).

Then, the calorie value is provided to the portable terminal 30 (S465).

In reproducing the fish-meat stuff photographed image, the portable terminal 30 displays the type and weight of the fish-meat stuff to be cooked measured by each of the divided regions of the cooking plate, and the calorie value which is obtained by converting the weight of the fish-meat stuff to be cooked into calorie value while overlapping with the fish-meat stuff photographed image (S470).

In other words, the type, weight and calorie information of the fish-meat stuff to be cooked, which are put on each of the divided regions of the cooking plate, are further displayed on the fish-meat stuff photographed image.

In addition, the cooking management service providing server 20 provides the banner advertisement data to the portable terminal 30 equipped with the cooking management dedicated app content (S475). Further, when the portable terminal 30 recognizes that at least a part of the banner advertisement data is clicked (S480), a purchase website linked with the banner advertisement data is displayed on the cooking management dedicated application content (S485). Here, the cooking management service providing server 20 may simultaneously provide the web page address information of the purchase website linked with the banner advertisement data together with the banner advertisement data, or provide the web page address information of the purchase website after the banner advertisement is clicked in the portable terminal 30.

Thereafter, the portable terminal 30 monitors whether or not the carbonization time point recognized from the fish-meat stuff detecting information is arrived (S490). If the carbonization time point comes, the carbonization time point is informed to the outside (S495).

### Advantageous Effects

According to the present disclosure, it is possible to provide an effect which enables real-time confirmation of a cooking process of fish-meat stuff which is placed on a heating device for cooking the fish-meat stuff even in the case of performing the other work at the remote place during cooking of the fish-meat stuff, to improve convenience when cooking the fish-meat stuff.

In addition, it is possible to provide an effect which enables reproduction of character images, music, and moving images through dedicated application content loaded on a portable terminal at a time waiting for fish-meat stuff to be cooked in the course of cooking the fish-meat stuff, to thereby eliminate boredom during cooking.

In addition, it is possible to provide an effect which enables displaying calorie information about the fish-meat stuff being consumed during cooking in dedicated application content, to thus provide a product capable of meeting the needs of modern people who are interested in diets. In addition, it is possible to provide an effect which improves advertising efficiency of an advertisement product even when a separate advertising medium is not used by connecting advertisement data of the product and a website for purchasing the product during use of a heating device for cooking fish-meat stuff.

In addition, it is possible to provide an effect of contributing to the industrial development by promoting the development through the development of the cooking appliance industry field and the dedicated application content technology field by combining the dedicated application content service with the fish-meat stuff cooking heating device, thereby improving the service quality.

In addition, it is possible to provide a technical effect which is capable of easily recognizing the degree of cooking of foods even when grilling foods with a camera by heating the foods to be grilled with infrared rays as a heat source, to enhance the texture of the grilled foods.

What is claimed is:

1. A system for providing a carbonization time point management service for cooking fish-meat stuff, the carbonization time point management service providing system comprising: a heating device for cooking fish-meat stuff in which the heating device which photographs fish-meat stuff to be cooked on a cooking plate with a camera and transmits the fish-meat stuff photographed image to a portable terminal.

2. The carbonization time point management service providing system of claim 1, wherein the heating device for cooking fish-meat stuff is connected to a cooking management service providing server performing a method comprising: estimating the type of the fish-meat stuff to be cooked and a carbonization time point by 1:1 mutual comparison with a previously stored fish-meat stuff identification image based on a fish-meat stuff photographed image; detecting the kind of the estimated fish-meat stuff to be cooked and the heat required for cooking; and providing fish-meat detecting information for controlling a cooking time to a portable terminal equipped with cooking management dedicated application content.

3. The carbonization time point management service providing system of claim 2, wherein the heating device for cooking fish-meat stuff and the cooking management service providing server are connected to a portable terminal performing a method comprising: transmitting the image of the fish-meat stuff taken from the heating device for cooking the fish-meat stuff to the cooking management service providing server, to thereafter receive the fish-meat stuff detecting information from the cooking management service providing server; generating a cooking completion acquisition signal in accordance with an end timing of the cooking time from a cooking start time point at which the fish-meat stuff to be cooked confirmed from the fish-meat stuff detecting information to a carbonization time point at which the fish-meat stuff to be cooked begins to carbonize; and transmitting the cooking completion acquisition signal to the cooking management dedicated application content to process a cooking completion indication signal to be informed to the outside.

4. The carbonization time point management service providing system of claim 3, wherein the cooking management service providing server comprises:
a fish-meat stuff identification unit for identifying a type of the fish-meat stuff to be cooked and a specific part of the fish-meat stuff to be cooked by comparing the fish-meat stuff received from a portable terminal with pre-stored fish-meat stuff identification images on a one-to-one basis;
a cooking time setting unit for predicting the cooking time from the cooking start time point to the carbonization time point at which the fish-meat stuff to be cooked starts to carbonize according to the type of the fish-meat stuff to be cooked; and
an information providing unit providing the fish-meat stuff detecting information including the type of the fish-meat stuff to be cooked and the cooking time to the portable terminal equipped with the cooking management dedicated application content.

5. The carbonization time point management service providing system of claim 4, wherein the cooking time setting unit calculates the cooking time on the basis of a relational expression
$$cooking time = \frac{type of fish or meat stuff \times thickness}{temperature of cooking plate} .$$

6. The carbonization time point management service providing system of claim 4, wherein the cooking management service providing server provides banner advertisement data to the portable terminal equipped with the cooking management dedicated application content, and when at least a part of the banner advertisement data is recognized to be clicked, a purchase website linked with the banner advertisement data is linked so as to be displayed on the cooking management dedicated application content.

7. The carbonization time point management service providing system of claim 3, wherein the portable terminal displays the fish-meat stuff photographed image using the cooking management dedicated application content during the cooking time.

8. The carbonization time point management service providing system of claim 7, wherein the fish-meat stuff photographed image is reproduced in the form of a video image into which at least one of customized character images, music, and images corresponding to a portable terminal holder who has determined priority based on a preference based on age, gender, occupation, and hobby acquired from the personal information of the portable terminal holder is inserted.

9. The carbonization time point management service providing system of claim 7, wherein a weight measuring unit for measuring the weight of fish-meat stuff to be cooked is provided in the heating device for cooking the fish-meat stuff to be cooked, wherein at least one of the weight measuring unit is disposed in each of the divided regions of the cooking plate, and measures weight of the fish-meat stuff to be cooked placed for each of the divided regions of the cooking plate, and
the portable terminal displays the weight of the fish-meat stuff to be cooked, which is measured for each of the divided regions of the cooking plate, when the fish-meat stuff photographed image is displayed, while overlapping with the fish-meat stuff photographed image.

10. The carbonization time point management service providing system of claim 9, wherein the portable terminal displays the calorie information obtained by converting the weight of the fish-meat stuff to be cooked into the calorie value when displaying the fish-meat stuff photographed image, while overlapping with the fish-meat stuff photographed image.

11. The carbonization time point management service providing system of claim 9, wherein the portable terminal generates different cooking completion acquisition signals for each of the divided regions and performs an on/off control of input/output values of the cooking completion display signal for causing at least one of the divided regions of the cooking plate to perform flickering or color conversion in accordance with the time point at which the cooking completion acquisition signal is generated.

12. The carbonization time point management service providing system of claim 11, wherein the portable terminal generates the cooking completion acquisition signal by further reflecting an optimum time for flipping, wherein the optimum time for flipping is calculated based on a relational expression
$$optimum time for flipping = \frac{cooking time}{2} .$$

13. A cooking management service providing server comprising:
a fish-meat stuff identification unit for identifying a type of the fish-meat stuff to be cooked and a specific part of the fish-meat stuff to be cooked by comparing the fish-meat stuff received from a portable terminal with pre-stored fish-meat stuff identification images on a one-to-one basis;
a cooking time setting unit for predicting the cooking time from the cooking start time point to the carbonization time point at which the fish-meat stuff to be cooked starts to carbonize according to the type of the fish-meat stuff to be cooked; and
an information providing unit providing the fish-meat stuff detecting information including the type of the fish-meat stuff to be cooked and the cooking time to the portable terminal equipped with the cooking management dedicated application content.
a content providing unit providing at least one of customized character images, music, and images corresponding to a portable terminal holder who has determined priority based on a preference based on age, gender, occupation, and hobby acquired from the personal information of the portable terminal holder, to the portable terminal equipped with the cooking management dedicated application content; and
a calorie information providing unit receiving a weight measurement value of the fish-meat stuff to be cooked placed for each of the divided regions of the cooking plate from the portable terminal and providing calorie information obtained by converting the weight of the fish-meat stuff to be cooked into a calorie value to the portable terminal equipped with the cooking management dedicated application content.

14. The cooking management service providing server of claim 13, wherein the cooking time setting unit calculates the cooking time based on a relational expression
$$cooking time = \frac{type of fish or meat stuff \times thickness}{temperature of cooking plate}$$
and calculates an optimum time for flipping on the basis of the relational expression
$$optimum time for flipping = \frac{cooking time}{2} .$$

15. A method of driving a carbonization time point management service providing system, the driving method comprising:
by a heating device for cooking the fish-meat stuff, photographing fish-meat stuff to be cooked which is placed on a cooking plate with a camera of the heating device and transmitting the photographed image of the fish-meat stuff to the portable terminal;
by a cooking management service providing server, performing a method comprising estimating the type of the fish-meat stuff to be cooked and a carbonization time point by 1:1 mutual comparison with a previously stored fish-meat stuff identification image based on a fish-meat stuff photographed image and providing fish-meat detecting information including the type of the fish-meat stuff to be cooked and the cooking time to the portable terminal equipped with cooking management dedicated application content; and
by the portable terminal, performing a method comprising transmitting the image of the fish-meat stuff taken from the heating device for cooking the fish-meat stuff to the cooking management service providing server, to thereafter receive the fish-meat stuff detecting information from the cooking management service providing server, generating a cooking completion acquisition signal in accordance with an end timing of the cooking time from a cooking start time point at which the fish-meat stuff to be cooked confirmed from the fish-meat stuff detecting information to a carbonization time point at which the fish-meat stuff to be cooked begins to carbonize, and transmitting the cooking completion acquisition signal to the cooking management dedicated application content to process a cooking completion indication signal to be informed to the outside.
